(19) United States
(12) Patent Application Publication
(10) Pub. No.: US 2009/0163655 A1
(43) Pub. Date: Jun. 25, 2009

(54) PRESSURE-SENSITIVE ADHESIVE WITH ENHANCED RESISTANCE TO WATER-WHITENING

(75) Inventors: Petra Shöcker, Bürstadt (DE); Cornelis Petrus Beyers, Altrip (DE); Stefan Kirsch, Nieder-Olm (DE); Ines Pietsch, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/296,500

(22) PCT Filed: Apr. 16, 2007
(86) PCT No.: PCT/EP2007/053677

§ 371 Date: Oct. 8, 2008

(30) Foreign Application Priority Data
Apr. 28, 2006 (EP) 06113275.9

(51) Int. Cl. C08F 2/22; C08L 33/00

(52) U.S. Cl. 524/832; 524/800; 524/827; 524/834; 524/836

(57) ABSTRACT

A pressure-sensitive adhesive comprising an aqueous polymer dispersion prepared by emulsion polymerization, wherein the polymer comprises monomers containing a hydroxyl group or primary amino group (referred to below collectively for short as hydrophilic monomers) and the polymer is obtainable by supplying more than 70% by weight of the hydrophilic monomers only when the polymerization mixture (mixture present in the polymerization vessel and composed of monomers and polymer already formed) already comprises more than 50% by weight of the total amount of monomers.

The invention relates to a pressure-sensitive adhesive comprising an aqueous polymer dispersion prepared by emulsion polymerization, wherein the polymer comprises monomers containing a hydroxyl group or primary amino group (referred to below collectively for short as hydrophilic monomers) and the polymer is obtainable by supplying more than 70% by weight of the hydrophilic monomers only when the polymerization mixture (mixture present in the polymerization vessel and composed of monomers and polymer already formed) already comprises more than 50% by weight of the total amount of monomers.

Self-adhesive articles are composed essentially of a backing applied to which there is a layer of pressure-sensitive adhesive. For many applications the backing is transparent. Water exposure is often accompanied by the phenomenon known as “blushing”, by which is meant a clouding in the adhesive layer caused by water penetration. This blushing detracts from the performance properties; naturally, it is in the case of transparent film-backed labels in particular that the clouding adversely affects the visual appearance.

EP-A 1 378 527, EP-A 623 659 or WO 98/44064, for example, discloses lessening the blushing in the case of aqueous polymer dispersions by means of specific synthesis components of the dispersed polymer. The result achieved is still not entirely satisfactory.

It was an object of the present invention, therefore, to lessen or avoid the effect of blushing while not adversely affecting but if possible even improving the other performance properties of the pressure-sensitive adhesive, in particular the adhesion and cohesion.

It is to this effect that the invention provides the pressure-sensitive adhesive defined at the outset.

The pressure-sensitive adhesive comprises a polymer dispersion prepared by emulsion polymerization. The emulsion addition polymer, called polymer for short, is composed preferably of at least 40%, more preferably at least 60%, and very preferably at least 80% by weight of what are called principal monomers.

The principal monomers are selected from C1-C20 alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising 1 to 10 carbon atoms, aliphatic hydrocarbons having 2 to 8 carbon atoms and one or two double bonds, or mixtures of these monomers.

Examples include (meth)acrylic acid alkyl esters having a C1-C10 alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Vinyl esters of carboxylic acids having 1 to 20 carbon atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether or vinyl isobutyl ether. Preference is given to vinyl ethers of alcohols comprising 1 to 4 carbon atoms.

Hydrocarbons having 2 to 8 carbon atoms and one or two olefinic double bonds include ethylene, propylene, butadiene, isoprene, and chloroprene.

Preferred principal monomers are the C1 to C10 alkyl acrylates and methacrylates, especially C1 to C8 alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate, and 2-ethylhexyl acrylate, styrene, and mixtures of these monomers.

Preferably the polymer is composed of at least 40%, in particular at least 60%, and very preferably at least 80% by weight of C1-C20, especially C1-C10 alkyl (meth)acrylates.

In accordance with the invention the polymer comprises monomers containing hydroxyl groups, primary amino groups or mixtures thereof (referred to collectively for short as hydrophilic monomers).

Monomers containing hydroxyl groups that may be mentioned in particular include C1-C10 hydroxyalkyl (meth)acrylates, preferably C2-C8 hydroxyalkyl (meth)acrylates, more preferably C2-C4 hydroxyalkyl (meth)acrylates, examples being hydroxyethyl (meth)acrylate, hydroxybutyl (meth)acrylate and hydroxyalkyl (meth)acrylate. The hydroxy acrylates are preferred over the hydroxy methacrylates.

As monomers containing primary amino groups mention may be made of, for example, methacrylamide or acrylamide.

The hydrophilic monomers are preferably selected from hydroxyalkyl (meth)acrylates, (meth)acrylamide or mixtures thereof.

The hydrophilic monomers are with particular preference monomers comprising hydroxyl groups, with very particular preference the above hydroxyalkyl (meth)acrylates.

The polymer comprises preferably in total 0.1% to 15% by weight of the hydrophilic monomers.

In particular the polymer comprises at least 0.2%, more preferably at least 0.3%, by weight of the hydrophilic monomers. In particular the polymer comprises not more than 10%, more preferably not more than 5%, and very preferably not more than 3%, by weight of the hydrophilic monomers.

Besides the principal monomers and the hydrophilic monomers the polymer may comprise further monomers, examples being monomers having acid groups (acid monomers; see above), e.g., carboxylic acid, sulfonic acid or phosphonic acid groups. Carboxylic acid groups are preferred. Examples that may be mentioned include acrylic acid, methacrylic acid, itaconic acid, maleic acid, and fumaric acid.

The amount of monomers of this kind containing acid groups is in particular 0.1% to 5%, more preferably 0.2% to 3% by weight in the polymer.

As further monomers mention may also be made of phenyloxyethyl glycol mono(meth)acrylate, glycidyl acrylate, glycidyl methacrylate, and amino (meth)acrylates such as 2-aminoethyl (meth)acrylate.

As further monomers mention may also be made of crosslinking monomers.

The glass transition temperature of the polymer is preferably −60 to 0° C., more preferably −60 to −10° C., and very preferably −60 to −20° C.

The glass transition temperature can be determined by typical methods such as differential thermoanalysis or differential scanning calorimetry (see, e.g., ASTM 3418/82, midpoint temperature).

Emulsion polymerization involves polymerizing ethylenically unsaturated compounds (monomers) in water using ionic and/or nonionic emulsifiers and/or protective colloids or stabilizers as surface-active compounds to stabilize the monomer droplets and the polymer particles formed subsequently from the monomers.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As surface-active substances it is preferred to use emulsifiers, whose molecular weights, unlike those of the protective colloids, are typically below 2000 g/mol. Where mixtures of surface-active substances are used the individual components must, as will be appreciated, be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

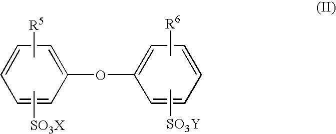

in which R5 and R6 are hydrogen or C4 to C14 alkyl and are not simultaneously hydrogen, and X and Y can be alkali metal ions and/or ammonium ions. Preferably R5 and R6 are linear or branched alkyl radicals having 6 to 18 carbon atoms or hydrogen, and in particular having 6, 12 and 16 carbon atoms, R5 and R6 not both simultaneously being hydrogen. X and Y are preferably sodium, potassium or ammonium ions, with sodium being particularly preferred. Particularly advantageous compounds 11 are those in which X and Y are sodium, R5 is a branched alkyl radical having 12 carbon atoms, and R6 is hydrogen or R5. It is common to use technical mixtures having a fraction of 50% to 90% by weight of the monoalkylated product, an example being Dowfax [symbol] 2A1 (trade mark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Emulsifier trade names are, for example, Dowfax [symbol] 2 A1, Emulan [symbol] NP 50, Dextrol [symbol] OC 50, Emulgator 825, Emulgator 825 S, Emulan [symbol] OG, Texapon [symbol] NSO, Nekanil [symbol] 904 S, Lumiten [symbol] I-RA, Lumiten E 3065, Disponil FES 77, Lutensol AT 18, Steinapol VSL, Emulphor NPS 25.

The surface-active substance is used typically in amounts of 0.1 to 10% by weight, based on the monomers to be polymerized.

In the emulsion polymerization use is made typically of water-soluble initiators for the free-radical polymerization of the monomers.

Water-soluble initiators for emulsion polymerization are, for example, ammonium salts and alkali metal salts of peroxydisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of typical redox initiator systems include ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures: for example, a mixture of the sodium salt of hydroxymethanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1 to 30% by weight, preferably 0.5 to 20% by weight, more preferably 1.0 to 10% by weight, based on the solution.

The amount of the initiators is generally 0.1 to 10% by weight, preferably 0.5 to 5% by weight, based on the monomers to be polymerized. It is also possible for two or more different initiators to be used for the emulsion polymerization.

In the course of the polymerization, polymerization regulators, regulators for short, can also be used in accordance with the invention. Regulators bring about a chain termination reaction and hence reduce the molar weight of the polymer. In the course of this reaction the regulators are attached to the polymer, generally to the chain end.

The amount of regulators can be, for example, 0 to 4 parts by weight, more preferably 0.05 to 0.8 part by weight, and very preferably 0.1 to 0.6 part by weight, based on 100 parts by weight of the monomers to be polymerized. Suitable regulators are, in particular, compounds having a mercapto group, such as tert-butyl mercaptan, thioglycolic acid ethylacrylic esters, mercaptoethynol, mercaptopropyltrimethoxysilane or tert-dodecyl mercaptan. The regulators are generally low molecular weight compounds having a molar weight of less than 2000, in particular less than 1000 g/mol.

A portion of the monomers can, if desired, be included in the initial charge to the polymerization vessel at the beginning of the polymerization; the remaining monomers, or all the monomers if no monomers are included in the initial charge, are added in the feed process in the course of the polymerization.

According to the invention the polymer is obtainable by supplying more than 70%, more preferably more than 90%, by weight of the hydrophilic monomers only when the polymerization mixture (mixture present in the polymerization vessel and composed of monomers and polymer already formed) already comprises more than 50% by weight of the total amount of monomers.

With particular preference the polymer is obtainable by supplying more than 70%, more preferably more than 90%, by weight of the hydrophilic monomers only when the polymerization mixture (mixture present in the polymerization vessel and composed of monomers and polymer already formed) already comprises more than 70% by weight of the total amount of monomers.

With very particular preference the polymer is obtainable by 100% by weight of the hydrophilic monomers being added only when the polymerization mixture (mixture present in the polymerization vessel and composed of monomers and polymer already formed) already comprises more than 50%, in particular more than 70%, with very particular preference more than 80% by weight of the total amount of monomers.

In all references to the polymerization mixture, the term monomer should be understood as including not only monomers which have not yet undergone polymerization but also monomer units of the polymer, i.e., the copolymerized monomers.

At the beginning of the addition of the more than 70% or of the more than 90% or 100% by weight of the hydrophilic monomers the polymerization mixture is composed of at least 40%, in particular at least 60%, by weight of polymer already formed.

The monomers are at least partly added continuously during the polymerization. In part it is also possible for monomers to be included in the initial charge to the polymerization vessel before the beginning of the polymerization.

Preferably not more than 30% by weight of the total amount of monomers, more preferably not more than 20% by weight, very preferably not more than 10% by weight of the monomers are included in the initial charge to the polymerization vessel.

The remaining monomers, i.e., preferably at least 70% by weight, more preferably at least 80% by weight, with very particular preference at least 90% by weight, are added continuously during the polymerization. In one particular embodiment no monomers are included in the initial charge, i.e., the entirety of the monomers is run in during the polymerization.

The temperature of the polymerization mixture during polymerization and, correspondingly, during the addition of the monomers is preferably at least 50° C., more preferably at least 70° C.

The addition of the monomers to the polymerization vessel takes place preferably over a period of at least two hours, more preferably at least 2.5 hours.

Otherwise, the conduct of the emulsion polymerization is subject to the following remarks:

The emulsion polymerization takes place in general at 30 to 130, preferably 50 to 90° C. The polymerization medium may be composed either of water alone or of mixtures of water and water-miscible liquids such as methanol. Preferably only water is used. The feed process may be conducted as a staged or gradient procedure. Preference is given to the feed process, in which a portion of the polymerization mixture is introduced as an initial charge and heated to the polymerization temperature, the polymerization of this initial charge is commenced, and then the remainder of the polymerization mixture is supplied to the polymerization zone, typically by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial polymerization charge.

The manner in which the initiator is added to the polymerization vessel in the course of the free-radical aqueous emulsion polymerization is known to the average skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove residual monomers it is common to add initiator after the end of the actual emulsion polymerization as well, i.e., after a monomer conversion of at least 95%.

With the feed process, the individual components can be added to the reactor from the top, through the side, or from below, through the reactor floor.

In the case of the emulsion polymerization, aqueous polymer dispersions with solids contents of generally 15% to 75% by weight, preferably of 40% to 75% by weight, are obtained.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at high solids content is the improved coating behavior at high solids contents. One or more new generations of particles can be produced at any point in time. This point in time depends on the particle size distribution which is targeted for a low viscosity.

The polymer thus prepared is used preferably in the form of its aqueous dispersion.

The polymer is preferably used as or in pressure-sensitive adhesives (PSAs).

The PSA comprises the polymer preferably in the form of the aqueous polymer dispersion as has been obtained, or is obtainable, by emulsion polymerization.

The PSA may be composed exclusively of the polymer, or of the aqueous dispersion of the polymer.

Alternatively the PSA may comprise further additives.

Suitable examples include a tackifier, i.e., a tackifying resin. Tackifiers are known for example from Adhesive Age, July 1987, pages 19-23 or Polym. Mater. Sci. Eng. 61 (1989), pages 588-592.

Tackifiers are, for example, natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M_{w} of below 30,000. The polyacrylates with preference are composed of at least 60%, in particular at least 80% by weight of C₁-C₈ alkyl (meth)acrylates.

Preferred tackifiers are natural or chemically modified rosins. Rosins are composed predominantly of abietic acid or abietic acid derivatives.

The tackifiers can be added in a simple way to the polymers of the invention, preferably to the aqueous dispersions of the polymers. In this case the tackifiers are preferably themselves in the form of an aqueous dispersion.

The amount by weight of tackifiers is preferably 5 to 100 parts by weight, more preferably 10 to 50 parts by weight, based on 100 parts by weight of polymer (solids/solids).

Besides tackifiers, for example, further additives may find use, examples being thickeners, preferably associative thickeners, defoamers, plasticizers, pigments, wetting agents or fillers, in the case of the PSA utility.

Accordingly the PSAs of the invention further comprise, in addition to the aqueous polymer dispersion, if appropriate, tackifiers and/or the above additives.

For improved surface wetting the PSAs may comprise, in particular, wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, in particular 0.1 to 3 parts by weight, per 100 parts by weight of polymer (solids).

The PSAs are suitable for producing self-adhesive articles such as labels, sheets or adhesive tapes. The PSA can be applied by typical methods, such as for example by rolling, knifecoating, spreading, etc., to backings, examples being paper or polymeric films, composed preferably of polyethylene, polypropylene, which may have been biaxially or monoaxially oriented, polyethylene terephthalate, polyvinyl chloride, polystyrene, polyamide or metal. Also suitable in particular are backings having nonpolar surfaces, made for example of polyolefins, especially polyethylene or polypropylene, since the dispersions of the invention adhere well to such backings.

The water can be removed preferably by drying at 50 to 150° C. Before or after the adhesive is applied the backings may be slit to form adhesive tapes, labels or sheets. For subsequent use the PSA-coated side of the substrates may be lined with a release paper, e.g., with a siliconized paper.

The self-adhesive articles of the invention have very good adhesive properties, in particular an effective adhesion to the substrates and a high level of cohesion (internal strength in the adhesive layer).

In particular the PSAs of the invention are suitable also for transparent backings, in particular not least for film-backed labels, since the “blushing” that frequently occurs on water exposure does not occur, or is at least lessened. Consequently the performance properties are effectively retained even on water exposure; there is no—or virtually no—clouding or other impairment of the visual appearance observed.

### COMPARATIVE EXAMPLE 1

### Without Hydrophilic Monomers

In a 4-liter polymerization reactor with anchor stirrer and heating/cooling apparatus a mixture of 223.9 g of deionized water and 18.2 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature were 10.3 g of a 7% strength by weight aqueous solution of sodium peroxodisulfate. After 3 minutes, feed streams 1 and 2 were started and were metered in at a uniform rate over 3 h.

Feed Stream 1 (An Aqueous Emulsion)

| | | |
|---|---|---|
| 595.6 | g | deionized water |
| 37.5 | g | a 32% strength by weight aqueous solution of |
| | | Disponil FES 77 (ethoxylated C12-C14 Na sulfate) |
| 4.1 | g | a 58% strength by weight aqueous solution of |
| | | Lumiten I-SC (succinic ester) |
| 825.0 | g | ethylhexyl acrylate |
| 267.0 | g | ethyl acrylate |
| 24.0 | g | styrene |
| 60.0 | g | methyl acrylate |
| 24.0 | g | acrylic acid |

Feed Stream 2

92.6 g a 7% strength by weight aqueous solution of sodium peroxodisulfate.

Feed Stream 3

12.2 g a 25% strength by weight ammonia solution and 24 g deionized water.

Feed Stream 4

12.0 g a 10% strength by weight aqueous solution of tert-butyl hydroperoxide.

Feed Stream 5

16.0 g a 12% strength by weight aqueous solution of sodium acetone disulfite.

Feed Stream 6

0.24 g Agitan LF 305.

Feed Stream 7

60.0 g deionized water.

After the end of feed streams 1 and 2, stirring was carried out for 30 minutes and then pH was adjusted using feed stream 3.

Subsequently feed streams 4 and 5 were commenced and were metered in at a uniform rate over 60 minutes.

After the end of feed streams 4 and 5, feed stream 6 and feed stream 7 were added.

The internal temperature of the reactor was lowered to 25° C. The aqueous polymer dispersion obtained had a solids content of 53.6% by weight. The average particle size was 178 nm.

### COMPARATIVE EXAMPLE 2

### Hydroxyethyl Acrylate Metered in at a Uniform Rate

In a 4-liter polymerization reactor with anchor stirrer and heating/cooling apparatus a mixture of 223.9 g of deionized water and 18.2 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature were 10.3 g of a 7% strength by weight aqueous solution of sodium peroxodisulfate. After 3 minutes, feed streams 1 and 2 were started and were metered in at a uniform rate over 3 h.

Feed Stream 1 (An Aqueous Emulsion)

| | | |
|---|---|---|
| 595.6 | g | deionized water |
| 37.5 | g | a 32% strength by weight aqueous solution of |
| | | Disponil FES 77 (ethoxylated C12-C14 Na sulfate) |
| 4.1 | g | a 58% strength by weight aqueous solution of |
| | | Lumiten I-SC (succinic ester) |
| 825.0 | g | ethylhexyl acrylate |
| 243.0 | g | ethyl acrylate |
| 24.0 | g | styrene |
| 60.0 | g | methyl acrylate |
| 24.0 | g | acrylic acid |
| 24.0 | g | hydroxyethyl acrylate |

Feed Stream 2

92.6 g a 7% strength by weight aqueous solution of sodium peroxodisulfate.

Feed Stream 3

12.2 g a 25% strength by weight ammonia solution and 24 g deionized water.

Feed Stream 4

12.0 g a 10% strength by weight aqueous solution of tert-butyl hydroperoxide.

Feed Stream 5

16.0 g a 12% strength by weight aqueous solution of sodium acetone disulfite.

Feed Stream 6

0.24 g Agitan LF 305.

Feed Stream 7

60.0 g deionized water.

After the end of feed streams 1 and 2, stirring was carried out for 30 minutes and then pH was adjusted using feed stream 3. Subsequently feed streams 4 and 5 were commenced and were metered in at a uniform rate over 60 minutes.

After the end of feed streams 4 and 5, feed stream 6 and feed stream 7 were added. The internal temperature of the reactor was lowered to 25° C. The aqueous polymer dispersion obtained had a solids content of 53.4% by weight. The average particle size was 193 nm.

### INVENTIVE EXAMPLE 1

### Hydroxyethyl Acrylate in Stage

In a 4-liter polymerization reactor with anchor stirrer and heating/cooling apparatus a mixture of 223.9 g of deionized water and 18.2 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature were 10.3 g of a 7% strength by weight aqueous solution of sodium peroxodisulfate.

### Feed Stream 1 (An Aqueous Emulsion)

| | | |
|---|---|---|
| 595.6 | g | deionized water |
| 37.5 | g | a 32% strength by weight aqueous solution of |
| | | Disponil FES 77 (ethoxylated C12-C14 Na sulfate) |
| 4.1 | g | a 58% strength by weight aqueous solution of |
| | | Lumiten I-SC (succinic ester) |
| 825.0 | g | ethylhexyl acrylate |
| 243.0 | g | ethyl acrylate |
| 24.0 | g | styrene |
| 60.0 | g | methyl acrylate |
| 24.0 | g | acrylic acid |

Feed stream 1 is divided. Two portions are formed:

Feed Stream 1a

⅔ of feed stream 1

Feed Stream 1b

⅓ of feed stream 1 with additional 24 g 2-hydroxyethyl acrylate.

Feed Stream 2

92.6 g a 7% strength by weight aqueous solution of sodium peroxodisulfate.

Feed Stream 3

12.2 g a 25% strength by weight ammonia solution and 24 g deionized water.

Feed Stream 4

12.0 g a 10% strength by weight aqueous solution of tert-butyl hydroperoxide.

Feed Stream 5

16.0 g a 12% strength by weight aqueous solution of sodium acetone disulfite.

Feed Stream 6

0.24 g Agitan LF 305.

Feed Stream 7

60.0 g deionized water.

After 3 minutes of addition of the amount of initiator, feed stream 1a (without hydroxyethyl acrylate) and feed stream 2 were commenced. Feed stream 1a (without HEA) was metered in over 2 h. Immediately after feed stream 1a (without HEA), feed stream 1b (with HEA) was commenced and was metered in over 1 h.

During the two feed streams 1a and 1b, feed stream 2 (initiator) was metered in over 3 hours.

After the end of feed streams 1a, 1b, and 2, stirring was carried out for 30 minutes. Thereafter the pH was adjusted using feed stream 3. Subsequently feed streams 4 and 5 were commenced and were metered in at a uniform rate over 60 minutes. After the end of feed streams 4 and 5, feed stream 6 and feed stream 7 were added.

The internal temperature of the reactor was lowered to 25° C. The aqueous polymer dispersion obtained had a solids content of 51.8% by weight. The average particle size was 207 nm.

### COMPARATIVE EXAMPLE 3

### Methacrylamide Metered in at a Uniform Rate, No Stage

In a 4-liter polymerization reactor with anchor stirrer and heating/cooling apparatus a mixture of 223.9 g of deionized water and 18.2 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature were 10.3 g of a 7% strength by weight aqueous solution of sodium peroxodisulfate. After 3 minutes, feed streams 1 and 2 were started and were metered in at a uniform rate over 3 h.

Feed Stream 1 (An Aqueous Emulsion)

| | | |
|---|---|---|
| 563.0 | g | deionized water |
| 37.5 | g | a 32% strength by weight aqueous solution of |
| | | Disponil FES 77 (ethoxylated C12-C14 Na sulfate) |
| 4.1 | g | a 58% strength by weight aqueous solution of |
| | | Lumiten I-SC (succinic ester) |
| 819.0 | g | ethylhexyl acrylate |
| 267.0 | g | ethyl acrylate |
| 24.0 | g | styrene |
| 60.0 | g | methyl acrylate |
| 24.0 | g | acrylic acid |
| 40.0 | g | methacrylamide, 15% form |

Feed Stream 2

92.6 g a 7% strength by weight aqueous solution of sodium peroxodisulfate.

Feed Stream 3

12.2 g a 25% strength by weight ammonia solution and 24 g deionized water.

Feed Stream 4

12.0 g a 10% strength by weight aqueous solution of tert-butyl hydroperoxide.

Feed Stream 5

16.0 g a 12% strength by weight aqueous solution of sodium acetone disulfite.

Feed Stream 6

0.24 g Agitan LF 305.

Feed Stream 7

60.0 g deionized water.

After the end of feed streams 1 and 2, stirring was carried out for 30 minutes and then pH was adjusted using feed stream 3.

Subsequently feed streams 4 and 5 were commenced and were metered in at a uniform rate over 60 minutes.

After the end of feed streams 4 and 5, feed stream 6 and feed stream 7 were added. The internal temperature of the reactor was lowered to 25° C. The aqueous polymer dispersion obtained had a solids content of 53.2% by weight. The average particle size was 189 nm.

### INVENTIVE EXAMPLE 2

### Methacrylamide, Stage

In a 4-liter polymerization reactor with anchor stirrer and heating/cooling apparatus a mixture of 223.9 g of deionized water and 18.2 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature were 10.3 g of a 7% strength by weight aqueous solution of sodium peroxodisulfate. Feed stream 1 was divided ½ and 1/2. Feed 1 was added to ½ of feed stream 1.

Feed 2 was 40 g methacrylamide, 15% form.

After 3 minutes, feed stream 1 (without methacrylamide) and feed stream 2 were commenced. Feed stream 1 without MAM was metered in over 1.5 h and feed stream 2 was metered in over 3 h. Immediately after feed stream 1 without MAM, feed stream 1 with MAM was commenced and was metered in over 1.5 h.

Feed Stream 1 (An Aqueous Emulsion)

| | | |
|---|---|---|
| 561.6 | g | deionized water |
| 37.5 | g | a 32% strength by weight aqueous solution of |
| | | Disponil FES 77 (ethoxylated C12-C14 Na sulfate) |
| 4.1 | g | a 58% strength by weight aqueous solution of |
| | | Lumiten I-SC (succinic ester) |
| 819.0 | g | ethylhexyl acrylate |
| 267.0 | g | ethyl acrylate |
| 24.0 | g | styrene |
| 60.0 | g | methyl acrylate |
| 24.0 | g | acrylic acid |

Feed Stream 2

92.6 g a 7% strength by weight aqueous solution of sodium peroxodisulfate.

Feed Stream 3

12.2 g a 25% strength by weight ammonia solution and 24 g deionized water.

Feed Stream 4

12.0 g a 10% strength by weight aqueous solution of tert-butyl hydroperoxide.

Feed Stream 5

16.0 g a 12% strength by weight aqueous solution of sodium acetone disulfite.

Feed Stream 6

0.24 g Agitan LF 305.

Feed Stream 7

60.0 g deionized water.

After the end of feed streams 1 and 2, stirring was carried out for 30 minutes. Thereafter the pH was adjusted using feed stream 3.

Subsequently the feed streams 4 and 5 were commenced and were metered in at a uniform rate over 60 minutes. After the end of feed streams 4 and 5, feed streams 6 and 7 were added.

The internal temperature of the reactor was lowered to 25° C. The aqueous polymer dispersion obtained had a solids content of 52.9% by weight. The average particle size was 185 nm.

TABLE 1
Composition of the polymers

| | Comparative | Comparative | Inventive | Comparative | Inventive |
|---|---|---|---|---|---|
| | example 1 | example 2 | example 1 | example 3 | example 2 |
| Ethylhexyl acrylate | 68.75 | 68.75 | 68.75 | 68.25 | 68.25 |
| Ethyl acrylate | 22.25 | 20.25 | 20.25 | 22.25 | 22.25 |
| Methyl acrylate | 5 | 5 | 5 | 5 | 5 |
| Styrene | 2 | 2 | 2 | 2 | 2 |
| Acrylic acid | 2 | 2 | 2 | 2 | 2 |
| Methacrylamide | | | | 0.5 | 0.5 |
| | | | | (cont.) | (staged) |
| 2-Hydroxyethyl | | 2 | 2 | | |
| acrylate | | (cont.) | (staged) | | |

Agitan LF 305 is a mixture of liquid paraffin and nonionic emulsifiers.

Performance Testing

The pressure-sensitive adhesives were coated directly onto a polyester film backing using a slotted doctor blade having a slot size of 60 pm and were dried at 90° C. for 3 minutes.

Procedure

Assessment: the visual appearance was assessed according to scores from 0 to 4:
0: no clouding
1: very slight clouding
2: more severe clouding
3: severe clouding
4: very severe clouding

### RESULTS

| Immersion time | | | | | |
|---|---|---|---|---|---|
| in water in | | | | | |
| seconds (s), | | | | | |
| minutes (min), | Comparative | Comparative | Inventive | Comparative | Inventive |
| or hours (h) | example 1 | example 2 | example 1 | example 3 | example 2 |
| 10 s | 0 | 0 | 0 | 0 | 0 |
| 30 s | 0 | 0 | 0 | 0 | 0 |
| 60 s | 1 | 0 | 0 | 1 | 1 |
| 3 min | 1 | 0 | 0 | 1 | 1 |
| 5 min | 1 | 0 | 0 | 1 | 1 |
| 10 min | 2 | 0 | 0 | 1 | 1 |
| 20 min | 2 | 0 | 0 | 1 | 1 |
| 30 min | 3 | 0 | 0 | 2 | 2 |
| 40 min | 4 | 0 | 0 | 3 | 2 |
| 60 min | | 1 | 0 | 3 | 3 |
| 2 h | | 2 | 2 | 3 | 3 |
| 3 h | | 3 | 2 | 3 | 3 |

1. A pressure-sensitive adhesive comprising an aqueous polymer dispersion prepared by emulsion polymerization, wherein the polymer comprises monomers containing a hydroxyl group or primary amino group, hereinafter referred to collectively as hydrophilic monomers, wherein the polymer is produced by supplying more than 70% by weight of the hydrophilic monomers only when the polymerization mixture present in the polymerization vessel and composed of monomers and polymer already formed comprises more than 50% by weight of the total amount of monomers.

2. The pressure-sensitive adhesive according to claim 1, wherein the polymer comprises at least 60% by weight of principal monomers, selected from C1 to C20 alkyl (meth)acrylates, vinyl esters of carboxylic acids comprising up to 20 carbon atoms, vinylaromatics having up to 20 carbon atoms, ethylenically unsaturated nitrites, vinyl halides, vinyl ethers of alcohols comprising 1 to 10 carbon atoms, aliphatic hydrocarbons having 2 to 8 carbon atoms and one or two double bonds, or mixtures of these monomers.

3. The pressure-sensitive adhesive according to claim 1, wherein the polymer is composed of at least 60% by weight of C1 to C20 alkyl (meth)acrylates.

4. The pressure-sensitive adhesive according to claim 1, wherein the hydrophilic monomers are selected from hydroxyalkyl (meth)acrylates, (meth)acrylamide or mixtures thereof.

5. The pressure-sensitive adhesive according to claim 1, wherein the polymer comprises in total 0.1% to 15% by weight of the hydrophilic monomers.

6. The pressure-sensitive adhesive according to claim 1, wherein the polymer is obtainable by supplying more than 90% by weight of the hydrophilic monomers only when the polymerization mixture present in the polymerization vessel and composed of monomers and polymer already formed already comprises more than 70% by weight of the total amount of monomers.

7. The pressure-sensitive adhesive according to claim 1, wherein the polymerization mixture at the beginning of addition of the more than 70% by weight of the hydrophilic monomers is composed of at least 60% by weight of polymer already formed.

8. A method for producing self-adhesive articles comprising employing the pressure-sensitive adhesive according to claim 1.

9. An aqueous polymer dispersion prepared by emulsion polymerization, wherein the polymer comprises monomers containing a hydroxyl group or primary amino group, hereinafter referred to collectively as hydrophilic monomers, wherein the polymer is produced by supplying more than 70% by weight of the hydrophilic monomers only when the polymerization mixture present in the polymerization vessel and composed of monomers and polymer already formed comprises more than 50% by weight of the total amount of monomers.

10. The pressure-sensitive adhesive according to claim 6, wherein the polymerization mixture at the beginning of addition of the more than 90% by weight of the hydrophilic monomers is composed of at least 60% by weight of polymer already formed.
